(19) United States
(12) Patent Application Publication
(10) Pub. No.: US 2019/0248196 A1
(43) Pub. Date: Aug. 15, 2019

(54) SNOW MELTING TIRE ASSEMBLY

(71) Applicants: Rebecca Cramer, Tracy, CA (US); Victoria Cramer, Tracy, CA (US); Victor Ramirez, JR., Tracy, CA (US)

(72) Inventors: Rebecca Cramer, Tracy, CA (US); Victoria Cramer, Tracy, CA (US); Victor Ramirez, JR., Tracy, CA (US)

(21) Appl. No.: 15/897,831

(22) Filed: Feb. 15, 2018

(51) Int. Cl. B60C 99/00

(52) U.S. Cl. CPC B60C 99/003

(57) ABSTRACT

A snow melting tire assembly for melting snow off of a tire includes a vehicle tire that includes an outer wall, an inner wall and a tread wall that extends between the inner and outer walls. The tread wall has an outer surface that has tread thereon. The inner and outer walls each have an inner perimeter edge that engages a rim. A heating system is mounted on the tire and heats the tire to melt snow off of the tire. The heating system includes an inner liner that is positioned on an interior surface of the outer wall, the inner wall and the tread wall. A plurality of heating elements is positioned in the inner liner such that the heating elements are in thermal communication with the outer, inner and tread walls wherein the outer, inner and tread walls are heated when the heating element is turned on.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to integrated vehicle tire heating devices and more particularly pertains to a new integrated vehicle tire heating device for melting snow off of a tire.

### BRIEF SUMMARY OF THE INVENTION

An embodiment of the disclosure meets the needs presented above by generally comprising a vehicle tire that includes an outer wall, an inner wall and a tread wall that extends between the inner and outer walls. The tread wall has an outer surface that has tread thereon. The inner and outer walls each have an inner perimeter edge that is configured to engage a rim. A heating system is mounted on the vehicle tire and heats the tire to melt snow off of the vehicle tire. The heating system includes an inner liner that is positioned on an interior surface of the outer wall, the inner wall and the tread wall. A plurality of heating elements is positioned in the inner liner such that the heating elements are in thermal communication with the outer, inner and tread walls wherein the outer, inner and tread walls are heated when the heating element is turned on.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a broken top side view of a vehicle tire and power switch of a snow melting tire assembly according to an embodiment of the disclosure.

FIG. 2 is a back view of an embodiment of the disclosure.

FIG. 3 is a side view of an embodiment of the disclosure.

FIG. 4 is a cross-sectional view of an embodiment of the disclosure taken along line 4-4 of FIG. 3.

FIG. 5 is a front view of an embodiment of the disclosure.

### DETAILED DESCRIPTION OF THE INVENTION

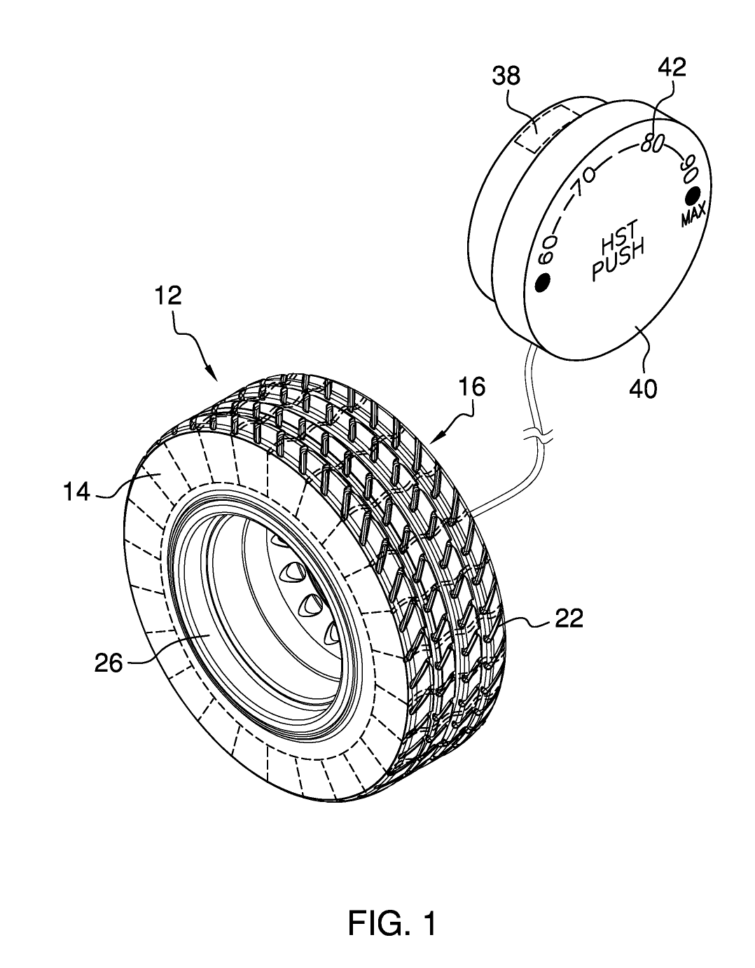

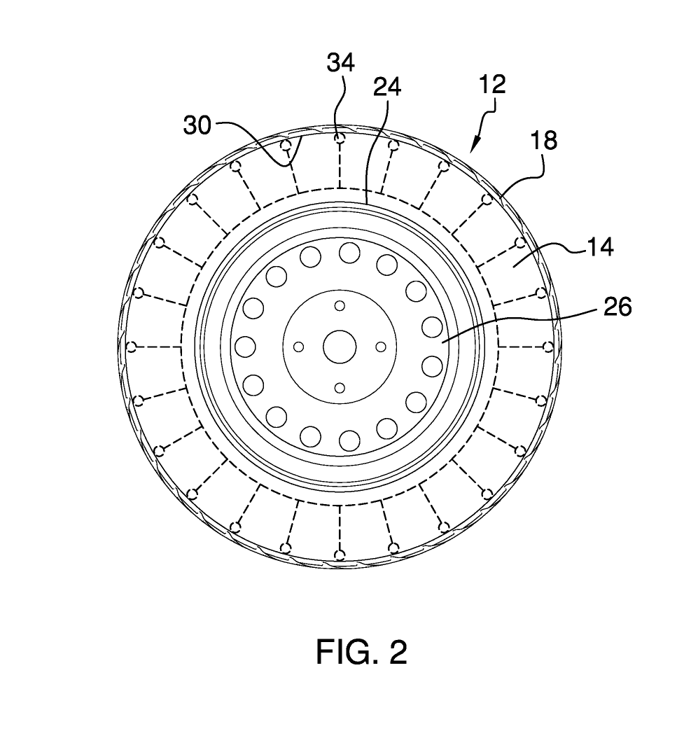

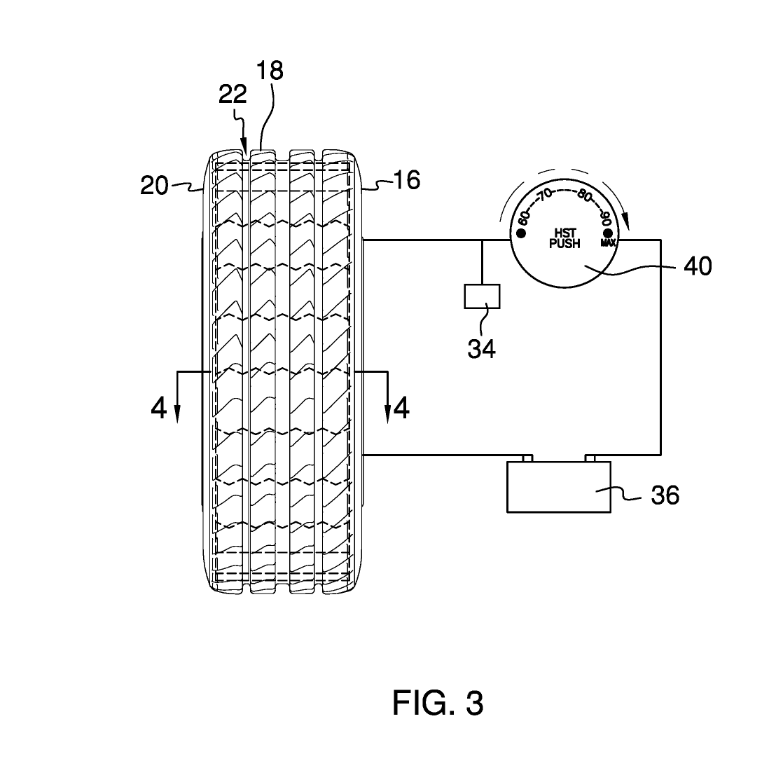

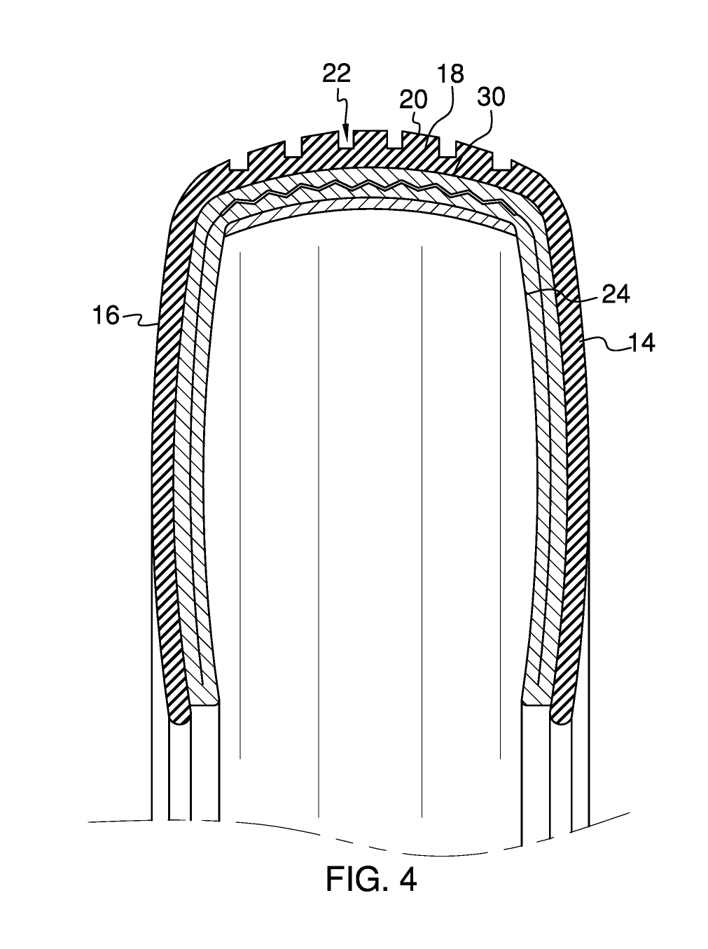

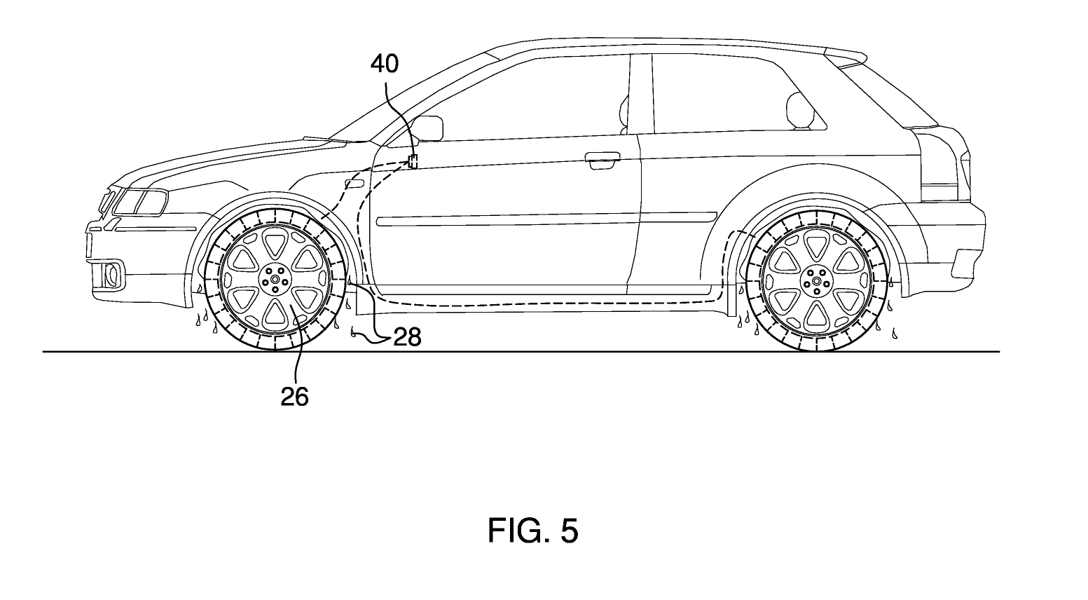

With reference now to the drawings, and in particular to FIGS. 1 through 5 thereof, a new integrated vehicle tire heating device embodying the principles and concepts of an embodiment of the disclosure and generally designated by the reference numeral 10 will be described.

As best illustrated in FIGS. 1 through 5, the snow melting tire assembly 10 generally comprises a vehicle tire 12 that includes an outer wall 14, an inner wall 16 and a tread wall 18 that extends between the inner 16 and outer walls 14. The tread wall 18 has an outer surface 20 with tread 22 thereon. The inner 16 and outer walls 14 each have an inner perimeter edge 24 that engages a rim 26.

A heating system is mounted on the vehicle tire 12 and heats the tire to melt snow 28 off of the vehicle tire 12. The heating system includes an inner liner 30 that is positioned on an interior surface 32 of the outer wall 14, the inner wall 16 and the tread wall 18. A plurality of heating elements 32 is positioned in the inner liner 30 such that the heating elements 32 are in thermal communication with the outer 14, inner 16 and tread walls 18 wherein the outer 14, inner 16 and tread walls 18 are heated when the heating element 34 is turned on.

A thermostat 34 is electrically coupled to each of the heating elements 32. The thermostat 34 regulates the heating element 34 such that the thermostat 34 turns off each of the heating elements 32 when the thermostat 34 detects a temperature that is beyond a threshold limit. The thermostat 34 turns on each of the heating elements 32 when the temperature is below the threshold limit. The threshold limit is typically less than 100° F., though may be less than 60° F. A power supply 36 is electrically coupled to the heating elements 32. The power supply 36 comprises a car battery. A control circuit 38 is electrically coupled to each of the heating elements 32. A power switch 40 is electrically coupled to the control circuit 38. The power switch 40 turns each of the heating elements 32 on or off. The power switch 40 has a series of heat level inputs 42 to selectively adjust a temperature of the heating elements. The power switch 40 may be positioned in the interior of a car 44. The power switch 40 may, for example, comprise a dial that be rotated to selectively adjust the temperature of the heating elements 32.

In use, the vehicle tire 12 is used in a conventional manner as tires are utilized. When the road 46 is covered with snow 28 the power switch 40 can be turned on to heat the vehicle tire 12. The heated vehicle tire 12 melts snow 28 off of the tire to prevent accumulation of snow 28 thereon and allow the tire treads 22 to retain friction. If the heating elements 32 reach the threshold temperature the thermostat 34 will shut off the heating elements 32 allowing the vehicle tire 12 to cool and prevent the vehicle tire 12 from overheating.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An integrated vehicle tire heating assembly configured for melting snow off of a vehicle tire, said assembly comprising:
a vehicle tire including an outer wall, a inner wall and a tread wall extending between said inner and outer walls, said tread wall having an outer surface having tread thereon, said inner and outer walls each having a inner perimeter edge being configured to engage a rim;
a heating system being mounted on said vehicle tire and heating said tire to melt snow off of said vehicle tire, said heating system includes:
an inner liner being positioned on an interior surface of said outer wall, said inner wall and said tread wall; and
a plurality of heating elements being positioned in said inner liner such that said heating elements are in thermal communication with said outer, inner and tread walls such that said outer, inner and tread walls are heated when said heating element is turned on.

2. The integrated vehicle tire heating assembly according to claim 1, wherein said heating system includes a thermostat being electrically coupled to each of said heating elements, said thermostat regulating said heating element such that said thermostat turns off each of said heating elements when said thermostat detects a temperature being beyond a threshold limit, said thermostat turning on each of said heating elements when said temperature is below said threshold limit.

3. The integrated vehicle tire heating assembly according to claim 2, wherein said threshold limit being less than 100° F.

4. The integrated vehicle tire heating assembly according to claim 1, wherein said heating system includes a power supply being electrically coupled to said heating elements.

5. The integrated vehicle tire heating assembly according to claim 4, wherein said power supply comprises a car battery.

6. The integrated vehicle tire heating assembly according to claim 1, wherein said heating system includes a control circuit being electrically coupled to each of said heating elements, a power switch being electrically coupled to said control circuit, said power switch turning each of said heating elements on or off.

7. The integrated vehicle tire heating assembly according to claim 1, wherein said power switch has a series of heat level inputs to selectively adjust a temperature of said heating elements.

8. An integrated vehicle tire heating assembly configured for melting snow off of a vehicle tire, said assembly comprising:
a vehicle tire including an outer wall, an inner wall and a tread wall extending between said inner and outer walls, said tread wall having an outer surface having tread thereon, said inner and outer walls each having an inner perimeter edge being configured to engage a rim;
a heating system being mounted on said vehicle tire and heating said tire to melt snow off of said vehicle tire, said heating system including:
an inner liner being positioned on an interior surface of said outer wall, said inner wall and said tread wall;
a plurality of heating elements being positioned in said inner liner such that said heating elements are in thermal communication with said outer, inner and tread walls such that said outer, inner and tread walls are heated when said heating element is turned on;
a thermostat being electrically coupled to each of said heating elements, said thermostat regulating said heating element such that said thermostat turns off each of said heating elements when said thermostat detects a temperature being beyond a threshold limit, said thermostat turning on each of said heating elements when said temperature is below said threshold limit, said threshold limit being less than 100° F.;
a power supply being electrically coupled to said heating elements, said power supply comprising a car battery; and
a control circuit being electrically coupled to each of said heating elements, a power switch being electrically coupled to said control circuit, said power switch turning each of said heating elements on or off, said power switch having a series of heat level inputs to selectively adjust a temperature of said heating elements.
